(19) United States
(12) Patent Application Publication
(10) Pub. No.: US 2009/0022564 A1
(43) Pub. Date: Jan. 22, 2009

(54) Anchor for screw fastener

(76) Inventor: Glenn Summerfield, Manasquan, NJ (US)

Correspondence Address: CLIFFORD G. FRAYNE, 136 DRUM POINT RD, SUITE 7A, BRICK, NJ, 08723, US

(21) Appl. No.: 12/214,102

(22) Filed: Jun. 18, 2008

Related U.S. Application Data
(60) Provisional application No. 60/959,782, filed on Jul. 18, 2007.

(51) Int. Cl. F16B 13/06

(52) U.S. Cl. 411/45

(57) ABSTRACT

An anchor for a screw fastener for hollow walls and doors and solid walls and doors, the anchor of two-piece construction having a nose piece with conical end portion and a cooperative lock nut which is drawn over the conical end portion of the nose piece upon influence of rotation of the screw causing the lock nut fingers to flare out and engage the interior surface of a hollow wall or the circumferential surface of a bore in a solid wall.

### RELATED APPLICATIONS

Applicant claims the benefit of provisional application 60/959,782, filed Jul. 18, 2007.

### BACKGROUND OF THE INVENTION

1. Field of the Invention

The present invention relates to anchors used in supporting articles on walls or doors, and in particular, the present invention relates to anchors for use on hollow walls and doors yet has application to solid walls and doors.

2. Description of the Prior Art

Hollow walls, which comprise most interior walls of building are generally comprised of a gypsum board, plaster board, drywall, or the like of a thickness generally of ½ to ⅝ths of an inch. This wall board is normally mounted on parallel, vertically oriented studs, thus forming a hollow or cavity defined by two adjacent studs and the wall board sheathing.

A similar situation rises in interior doors, which are often time framed out and covered by a thin wooden veneer on both sides, which again creates hollows or cavities in the door defined as a space between the framing and the opposing veneer sheathing.

The gypsum board, plaster board, door sheathing, drywall or plaster are of limited structural integrity and in the case of gypsum board, dry wall or plaster board owe much of its strength to the paper used to enclose the compressed powder. They will not adequately support items hung thereon with simple nails, or even standard screws, unless the fasteners in the form of nails or screws pass through the gypsum board, drywall, plaster board or the like and are anchored in one of the interior studs. Since these studs are spaced apart per construction codes, an interior wall has significantly greater hollow space than it does solid space (i.e. drywall stud drywall).

As a result of this excess hollow space, the homeowner oftentimes finds himself having to anchor a fastener in an interior wall in a location in which the fastener only penetrates the gypsum board, plaster board or drywall or the like. This need could be for hanging a decorative item, such as a painting or mirror, or for hanging utility items, such as shelving.

There are a myriad of hollow wall anchors which have been developed and are used in conjunction with a nail or screw for enhancing holding strength in these situations. Common anchors of this type often have drawbacks. Plug anchors made of metal, plastic or fiber which are expanded by an inserted screw against the interior gypsum of the wall board still rely on the tenuous holding strength provided by compressed powder gypsum. Other anchors include toggle bolts, which cannot be reused and which require pre-drilled holes for installation. Self-installing drive-in molly bolt anchors may damage a wall if not properly installed. Many of the hollow wall anchors are susceptible to loosening and failure, particularly with a dynamic load, such as the removal and replacement of pictures or paintings or other typical wall vibrations.

Still further, many anchors exert a spreading force on their apertures, which is not always reliable and secure, and can cause the fastener to fail over time under heavier weight loads. Self-drilling anchors leave a large hole in the drywall, and are not useful for thin panels such as sheathing veneer on hollow doors, or on plaster. Metal toggle bolts require a large hole and are not normally useful in hollow doors or plaster. Molly bolts are not useful for hollow doors or plasters, and are difficult to remove, leaving a large hole in the drywall.

Each of the aforesaid prior art anchors are also susceptible to be easily over-tightened such that they distort the drywall, gypsum board or plaster board, which affects the aperture through which they are inserted, and thus may weaken their intended purpose.

Applicant's novel contribution to the art addresses the shortcomings of the prior art fasteners and introduces a unique two-piece design anchor requiring a small aperture in which does not distort the surface and eliminates the possibility of over-tightening, and in many instances, presents an anchor which can be reused. Applicant's anchor also has application not only to hollow walls and doors, but also solid walls and doors.

### OBJECTS OF THE INVENTION

An object of the present invention is to provide for a novel hollow wall anchor of two-piece design which does not distort the surface through which it is inserted, and which eliminates the possibility of over-tightening so as to deform or distort the anchoring material.

A still further object of the present invention is to provide for a unique hollow wall fastener of two-piece construction wherein the two pieces are interchangeable such that the fastener can accommodate wall material of different thicknesses.

A still further object of the present invention is to provide for a novel hollow wall fastener which can be reused.

A still further object of the present invention is to provide for a novel fastener anchor for solid walls and doors.

### SUMMARY OF THE INVENTION

An anchor for a screw fastener for hollow walls and doors and solid walls and doors, the anchor of two-piece construction having a nose piece with conical end portion and a cooperative lock nut which is drawn over the conical end portion of the nose piece upon influence of rotation of the screw causing the lock nut fingers to flare out and engage the interior surface of a hollow wall or the circumferential surface of a bore in a solid wall.

### BRIEF DESCRIPTION OF THE DRAWINGS

These and other objects of the present invention will become apparent, particularly when taken in light of the following illustrations wherein:

FIG. 1 is an exploded side view of the anchor of the present invention;

FIG. 2 is a side view of the anchor of the present invention in the course of being installed to a hollow wall;

FIG. 3 is a side view of the anchor of the present invention in a fully fixed, secure, installed position in a hollow wall;

FIG. 4 is a side view of the anchor of the present invention utilized to secure an object to a solid wall; and

FIG. 5 is a partial end view of a portion of the anchor assembly.

### DETAILED DESCRIPTION OF THE INVENTION

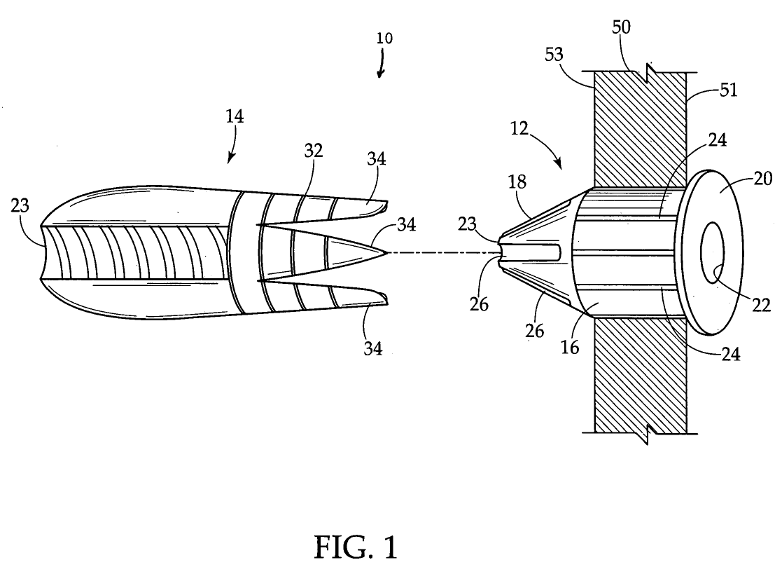

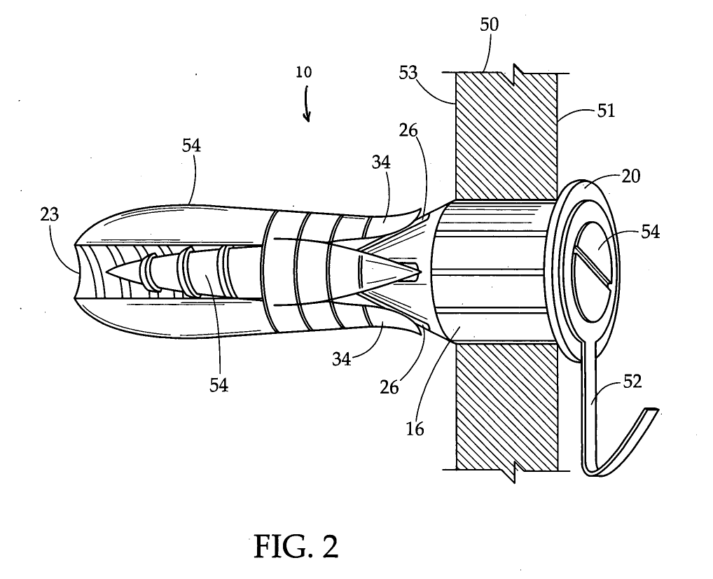

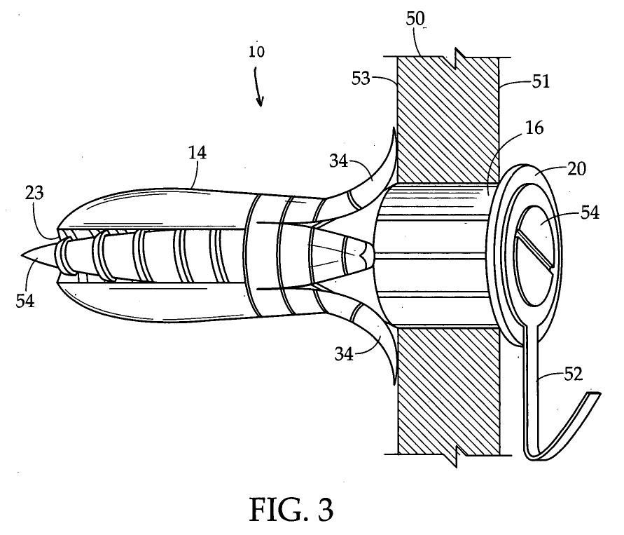

FIG. 1 is an exploded view of the anchor 10 of the present invention, FIG. 2 is a side view of the anchor 10 of the present invention in the course of being installed to a hollow wall, FIG. 3 is a side view of the anchor 10 of the present invention fully installed in a hollow wall, and FIG. 5 is a partial end view of a finger of the lock nut assembly.

Anchor 10 is of two piece construction having a nose piece 12 and a cooperative lock nut 14. Nose piece 12 comprises a barrel member 16 of generally cylindrical construction having a truncated conical end portion 18 and a flange end 20. Centrally disposed through both the flange end 20, barrel member 16 and truncated conical end portion 18, is a throughbore 22.

Formed about the circumference of barrel member 16 are a plurality of axial upstanding ridges 24 in parallel relationship with throughbore 22. Formed on truncated conical end portion 18 are a plurality of slots or voids 26 which radiate from truncated conical end 23 towards barrel member 16.

Lock nut 14 is tubular in shape having a threaded throughbore 23. First end 32 of lock nut 14 is formed with a plurality of fingers 34, the number of fingers 34 being equal to the number of slots or voids 26 formed on truncated conical end portion 18 of nose piece 12. Fingers 34 have a concave profile in order to cooperate with truncated conical end portion 18 of nose piece 12 (See FIG. 5). Formed on the inner surface 36 of fingers 34 are upstanding ridges 38. Upstanding ridges 38 are slidably receivable within slots or voids 26 on nose piece 12 as hereinafter described. In the preferred embodiment, the leading edge of upstanding ridges 38 would be beveled or rounded for ease of engagement with slots or voids 26.

Referring to FIGS. 2 and 3 and the installation of anchor 10, the appropriate location on the wall 50 would be identified for the installation of the anchor. A suitable aperture would be drilled into wall 50. The diameter of the aperture would approximate the diameter of the barrel member 16 of nose piece 12 absent axial upstanding ridges 24. This aperture would normally be in the range of from quarter to five sixteenths of an inch. The hook 52 or other piece of hardware to be positioned on the wall would be juxtaposed flange end 20 of nose piece 12. A threaded fastener 54, in the form of the screw, would then be inserted through the aperture 56 in the hardware, through throughbore 22 of nose piece 12 and into threaded inner tubular throughbore 22 of lock nut 14. Threaded fastener 54 would then be rotated, engaging the threaded inner tubular throughbore 22 of locknut 14 so as to draw locknut 14 towards nose piece 12 such that the upstanding ridges 38 on fingers 34 of locknut 14 engage with slots or voids 26 on truncated conical end portion 18 of nose piece 12.

With the nose piece 12 and lock nut 14 assembly thus completed, the lock nut 14 and nose piece 12 are inserted into the aperture formed in wall 50 until flange end 20 of nose piece 12 is juxtaposed the outer surface 51 of wall 50. The hook or alternative hardware 52 is now similarly juxtaposed the outer surface 51 of wall 50.

The threaded fastener 54 would then be further rotated so as to draw lock nut 14 towards barrel member 16 of nose piece 12, which due to the cooperation between truncated conical end portion 18 and fingers 34 on lock nut 14, causes the fingers 34 to bend or extend outwardly until as illustrated in FIG. 3, the end tips of fingers 34 are juxtaposed the inner surface 53 of wall 50. The bend or outward extension of fingers 34 is facilitated by annular grooves 32 formed in fingers 34.

In the process just described, the axial ridges 24 on barrel member 16 of nose piece 12 prevent the rotation of nose piece 12 by engaging the wall 50 about the periphery of the drilled aperture.

The upstanding ridges 38 on fingers 34 cooperate with the slots or voids 26 on truncated conical end portion 18 of nose piece 12 to prevent locking nut 14 from freely rotating. Therefore, under the influence of the threaded fastener 54, locking nut 14 must move axially towards nose piece 12, thus causing fingers 34 to bend or spread outwardly so as to engage the inner surface 53 of wall 50.

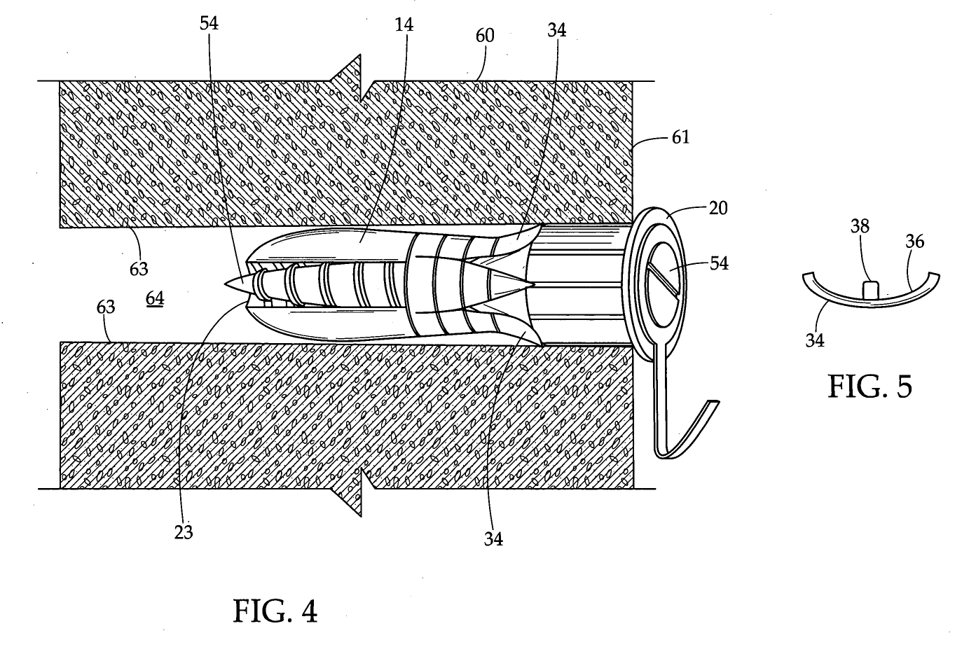

FIG. 4 is a side view of anchor 10 being utilized with respect to a solid wall. The structure of anchor 10 remains the same. An appropriate aperture is drilled into the solid wall 60. Anchor 10 and the hardware 52 that it is to secure is then inserted into the aperture until flange end 20 is juxtaposed the outer surface 61 of the solid wall 60. The threaded fastener 54 is then rotated which causes fingers 34 on lock nut 14 to spread such that they frictionally engage the inner surface 63 of the bore 64 which was drilled resulting in a firm fastening of all components.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A wall anchor assembly for fixing a securing means for an article of manufacture to a hollow wall, said wall anchor assembly comprising:
a nose member, said nose member having a barrel member having a truncated conical first end portion and a planar opposing flange end portion, said nose piece having a centrally disposed throughbore, said nose piece having a plurality of axially upstanding ridges in parallel relationship spaced about the outer circumference of said barrel member, said truncated conical first end portion having a plurality of slots radiating from said truncated conical first end portion toward said barrel member;
a lock nut, tubular in cross section having a threaded throughbore, said lock nut having a first end formed with a plurality of deformable fingers; said fingers having a concave profile and having formed on the inner surface thereof, an upstanding ridge, said upstanding ridges being slidably receivable within said slots on said truncated conical first end portion of said nose piece; and
a threaded fastener positioned through a securing means for support of an article of manufacture, through said throughbore in said nose piece and engaging said threaded throughbore of said lock nut, with said upstanding ridges formed on the inner surface of said fingers of said lock nut in alignment with said slots on said truncated conical first end portion of said nose piece, said lock nut and said nose piece and said threaded fastener inserted through an aperture in a hollow wall until said flange end portion of said nose piece abuts said hollow wall, said aperture approximating the diameter of said nose piece, wherein the rotation of said threaded fastener in said threaded throughbore of said lock nut draws said lock nut toward said nose piece causing said fingers of said lock nut to expand outwardly cooperatively with said upstanding ridges on said inner surface of said fingers and said slots on said truncated conical first end portion until said fingers abut an inner surface of said hollow wall.

2. The wall anchor assembly in accordance with claim 1 wherein said barrel member of said nose member is cylindrical in cross section having upstanding axial ridges.

3. The wall anchor assembly in accordance with claim 1 wherein said plurality of slots radiating from said truncated, conical first end portion of said nose member and said upstanding ridges on said inner surface of said lock nut are cooperative to prevent the independent rotation of the nose member in relationship to the lock nut during rotation of said threaded fastener.

4. The wall anchor assembly in accordance with claim 1 wherein said plurality of deformable fingers on said lock nut are tapered.
